(19) United States
(12) Patent Application Publication
(10) Pub. No.: US 2010/0245703 A1
(43) Pub. Date: Sep. 30, 2010

(54) LIQUID CRYSTAL DISPLAY

(75) Inventor: Chi-Sheng Lin, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/480,696

(22) Filed: Jun. 9, 2009

(30) Foreign Application Priority Data
Mar. 26, 2009 (TW) 98204812

(51) Int. Cl. G02F 1/13357

(52) U.S. Cl. 349/58; 349/62

(57) ABSTRACT

A liquid crystal display (LCD) includes an LCD panel, a backlight module, and a circuit board. The backlight module disposed under the LCD panel includes a back plate, a light emitting diode (LED) light source, a protrusion, and a light guide plate. The LED light source disposed in the back plate includes a substrate and LEDs. The protrusion and the LEDs are disposed on the substrate, and the protrusion has first power contacts. The light guide plate is disposed between the back plate and the LCD panel and has a light entering surface. A light emitting surface of each of the LEDs faces the light entering surface. The circuit board disposed under the back plate is electrically connected to the LCD panel. The circuit board has a circuit layout and second power contacts, and the second power contacts contact the first power contacts correspondingly.

### CROSS-REFERENCE TO RELATED APPLICATION

This application claims the priority benefit of Taiwan application serial no. 98204812, filed on Mar. 26, 2009. The entirety of the above-mentioned patent application is hereby incorporated by reference herein and made a part of specification.

### BACKGROUND OF THE INVENTION

1. Field of Invention

The present application generally relates to a display, and more particularly, to a liquid crystal display (LCD).

2. Description of Related Art

With advancement of technologies, digital devices including mobile phones, digital cameras, digital video cameras, notebook computers, and desktop computers have made progress to meet requirements for easy operation, powerful functionality, and embellished exterior design. Using information technology (IT) products as described above demands suitable display screens acting as man-machine interfaces because display functions of the display screens of the IT products facilitate various operations. Among the display screens, LCDs have become the mainstream products in the market. Nonetheless, LCD panels of the LCDs are not capable of emitting light, and therefore backlight modules disposed under the LCD panels are required for providing light sources and achieving display functions.

FIG. 1 is a schematic three-dimensional partial exploded view illustrating a conventional backlight module. Referring to FIG. 1, the backlight module 100 includes a back plate 110, a light emitting diode (LED) light source 120, a light guide plate 130, a sealant 140, a power connection line 150, and a light source driving circuit board 160. Here, the LED light source 120 and the light guide plate 130 are disposed between the back plate 110 and the sealant 140. Besides, an end of the power connection line 150 is connected to the LED light source 120, while the other end of the power connection line 150 penetrates the back plate 110 and connects the light source driving circuit board 160.

FIG. 2A is a schematic view of a conventional power connection line connecting an LED light source. Referring to FIG. 2A, according to the related art, one end of the power connection line 150 is connected to the LED light source 120 by thermal compression. Likewise, the other end of the power connection line 150 is connected to the light source driving circuit board 160 by way of thermal compression as well. As such, the LED light source 120 is electrically connected to the light source driving circuit board 160 through the power connection line 150 depicted in FIG. 1.

FIG. 2B is a schematic view of another conventional power connection line connecting an LED light source. Referring to FIG. 2B, according to the related art, a connector 170 is disposed on the LED light source 120, and one end of the power connection line 150 is inserted into the connector 170. Similarly, another connector 170 is disposed on the light source driving circuit board 160, and the other end of the power connection line 150 depicted in FIG. 1 is inserted into the connector 170 disposed on the light source driving circuit board 160, such that the LED light source 120 is electrically connected to the light source driving circuit board 160 through the power connection line 150.

FIG. 3 is a schematic view of a conventional LCD module. Referring to FIG. 3, an LCD panel 200 is disposed on the backlight module 100 and then covered by a front frame 210, such that the LCD panel 200 is fixed onto the backlight module 100, and then an LCD 300 is formed.

Based on the above, the power connection line 150 is connected between the LED light source 120 and the light source driving circuit board 160 through thermal compression or manual assembly, and thus defects are prone to occur during the thermal compression and the manual assembly. Moreover, the power connection line 150 is connected to the light source driving circuit board 160 after penetrating the back plate 110, and thereby assembling time cannot be effectively reduced. Further, an LCD panel driving circuit board (not shown) electrically connected to the LCD panel 200 is further disposed in the LCD 300 to drive the LCD panel 200. Namely, the two circuit boards, i.e., the light source driving circuit board 160 and the LCD panel driving circuit board, are disposed under the back plate 110 of the LCD 300.

### SUMMARY OF THE INVENTION

The present application is directed to an LCD whereby manufacturing costs can be effectively lowered down, and assembling time can also be reduced.

An LCD including an LCD panel, a backlight module, and a circuit board is provided herein. The backlight module disposed under the LCD panel includes a back plate, an LED light source, a protrusion, and a light guide plate. The LED light source is disposed in the back plate. Besides, the LED light source includes a substrate and a plurality of LEDs. The LEDs are disposed on the substrate. The protrusion is also disposed on the substrate of the LED light source, and the protrusion has a plurality of first power contacts. The light guide plate is disposed between the back plate and the LCD panel and has a light entering surface. In addition, a light emitting surface of each of the LEDs faces the light entering surface of the light guide plate. The circuit board is disposed under the back plate and electrically connected to the LCD panel. The circuit board has a circuit layout and a plurality of second power contacts, and the second power contacts contact the first power contacts correspondingly.

According to an embodiment of the present invention, the substrate has an LED disposing region and a protrusion disposing region located at one side of the LED disposing region. The LEDs are disposed in the LED disposing region, and the first power contacts are disposed in the protrusion disposing region.

According to an embodiment of the present invention, the back plate has an opening exposing the first power contacts of the protrusion. Besides, the first power contacts protrude from the back plate.

According to an embodiment of the present invention, the first power contacts are bumps, leaf springs, or bonding pads.

According to an embodiment of the present invention, the second power contacts are bumps, leaf springs, or bonding pads.

According to an embodiment of the present invention, the LCD further includes a front frame covering the LCD panel. The LCD panel is fixed onto the backlight module by using the front frame.

According to an embodiment of the present invention, the backlight module further includes at least an optical film disposed between the LCD panel and the light guide plate. Here, the optical film is a diffusion film, a prism sheet, a brightness enhancement film, or a combination thereof.

According to an embodiment of the present invention, the LCD further includes a flexible flat cable connected between the LCD panel and the circuit board.

In light of the foregoing, the protrusion of the LCD is disposed on the substrate of the LED light source according to an embodiment of the present invention, and the first power contacts and the second power contacts correspondingly contacted thereto are disposed on the circuit board and the protrusion, such that the corresponding first and second power contacts are contacted and electrically connected, and that the LED light source emits light. In comparison with the conventional LCD, the LCD of the present application is conducive to reduction of material costs because disposition of the light source driving circuit board and the power connection line are not needed. Moreover, the step of penetrating the back plate with the power connection line and thermally compressing or manually assembling the power connection line to the light source driving circuit board can be omitted, thereby saving costs and time of manual assembly.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional partial exploded view illustrating a conventional backlight module.

FIG. 2A is a schematic view of a conventional power connection line connecting an LED light source.

FIG. 2B is a schematic view of another conventional power connection line connecting an LED light source.

FIG. 3 is a schematic view of a conventional LCD module.

FIG. 4 is a schematic partial exploded view of an LCD according to an embodiment of the present invention.

FIG. 5 is a schematic partial view of assembling the LCD depicted in FIG. 4.

FIG. 6 is a schematic side view illustrating the LCD depicted in FIG. 5.

FIG. 7 is a schematic three-dimensional view illustrating the circuit board depicted in FIG. 5 when the circuit board is not placed on a back plate of the backlight module.

FIG. 8 is a schematic view of a circuit board and an LCD panel.

FIG. 9A is a schematic view of first power contacts according to another embodiment of the present invention.

FIG. 9B is a schematic view of second power contacts according to another embodiment of the present invention.

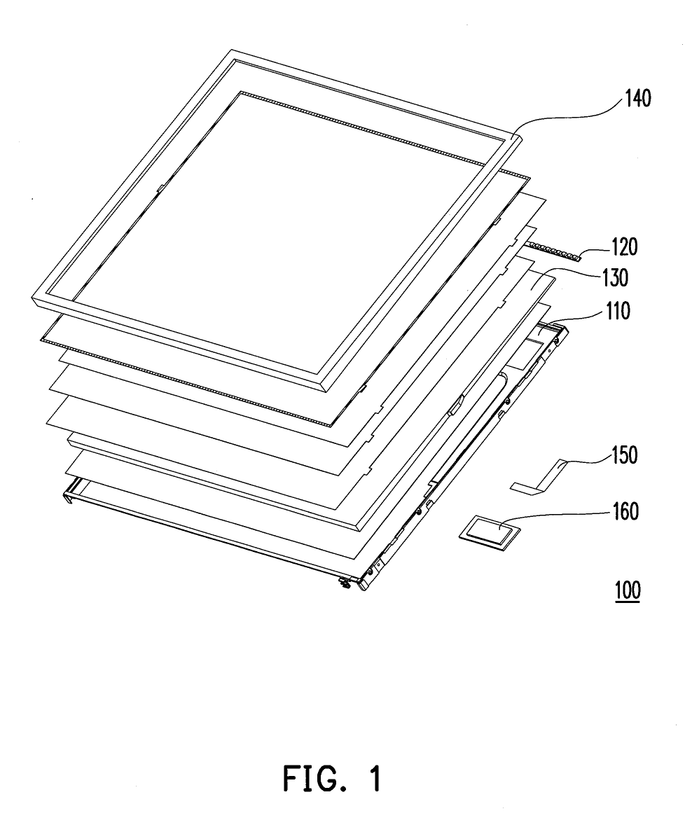

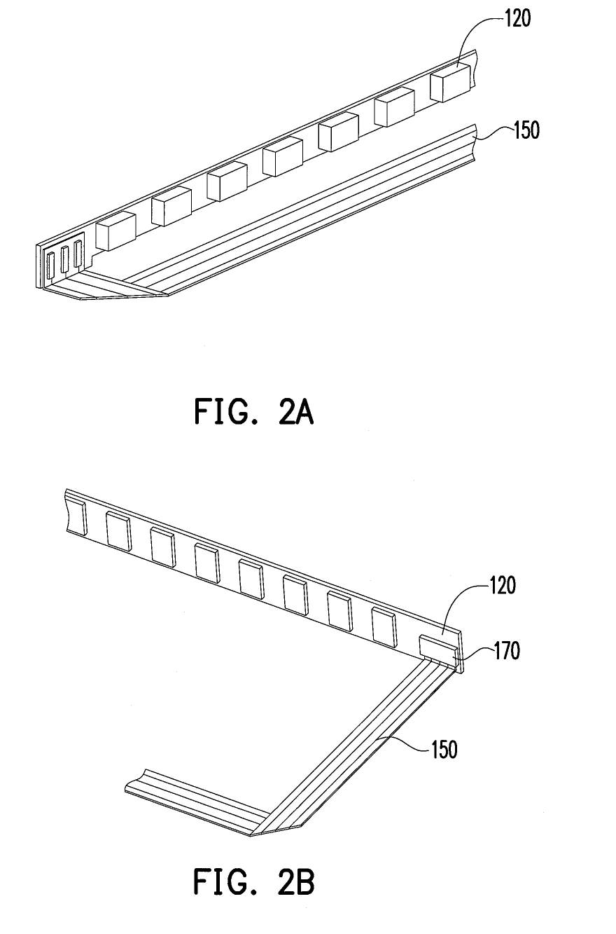

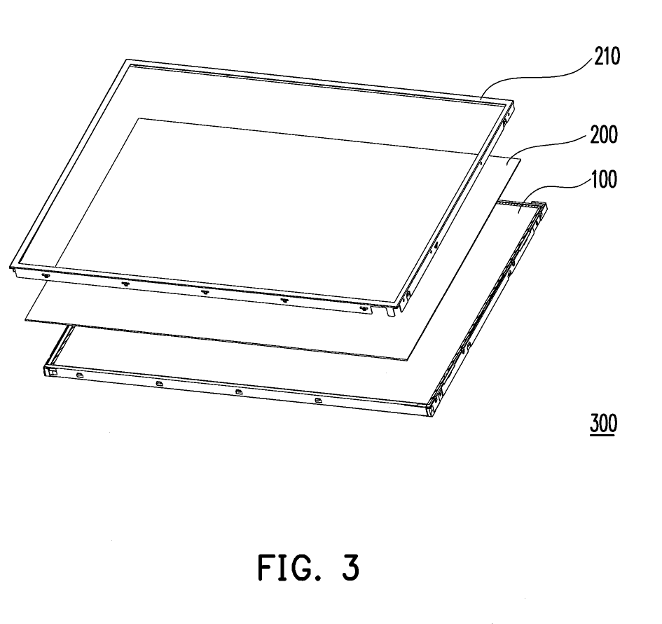

### DESCRIPTION OF EMBODIMENTS

Terminologies such as “up,” “down,” “left,” and “right” are applicable to the embodiments shown and described in conjunction with the drawings. These terminologies are merely for the purposes of description and do not necessarily applied to the position or manner in which the invention may be constructed for actual use. It should be known that relative correlations of same elements at different viewing angles are distinct in different drawings.

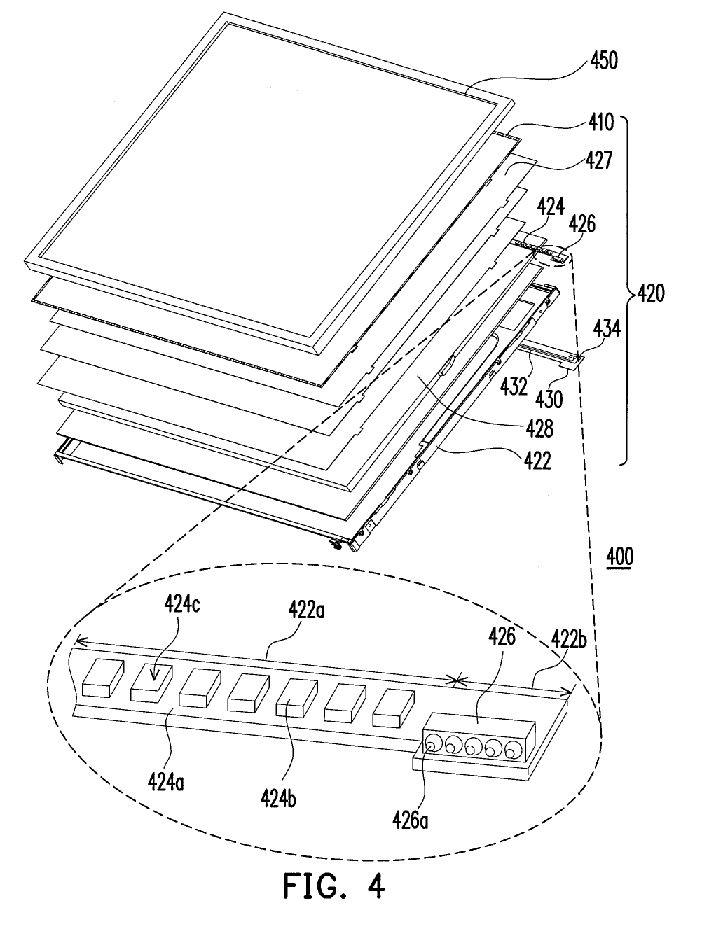

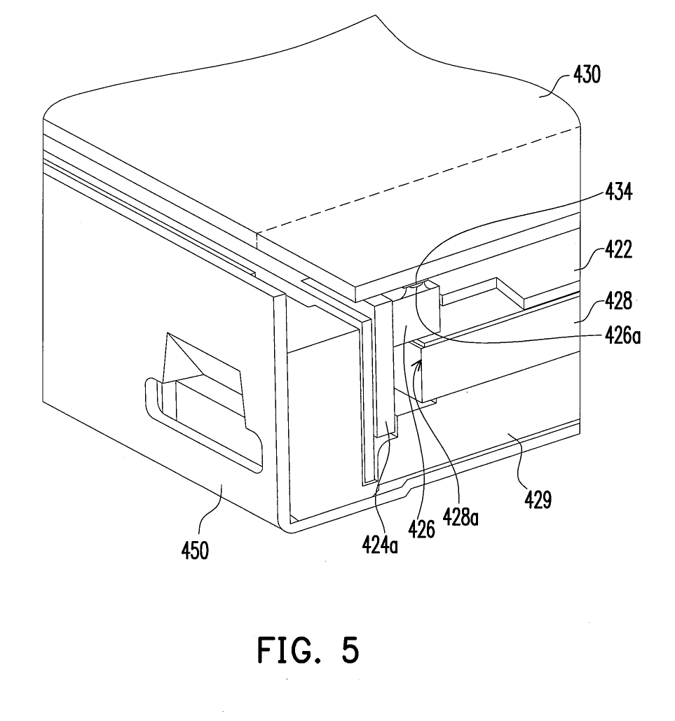

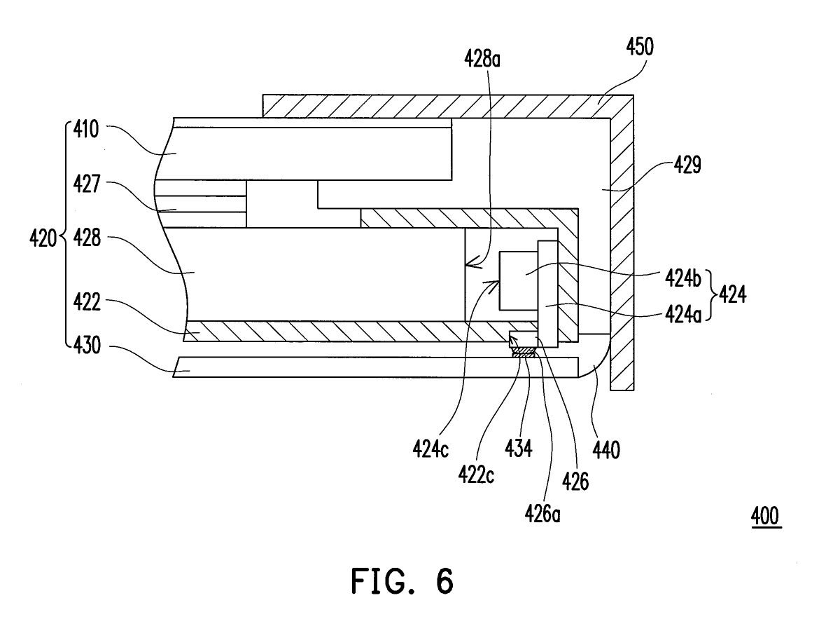

FIG. 4 is a schematic partial exploded view of an LCD according to an embodiment of the present invention. FIG. 5 is a schematic partial view of assembling the LCD depicted in FIG. 4. FIG. 6 is a schematic side view illustrating the LCD depicted in FIG. 5. Referring to FIGS. 4, 5, and 6, the LCD 400 includes an LCD panel 410, a backlight module 420, and a circuit board 430. The backlight module 420 is disposed under the LCD panel 410. The backlight module 420 includes a back plate 422, an LED light source 424, a protrusion 426, and a light guide plate 428. The LED light source 424 is disposed in the back plate 422. Besides, the LED light source 424 includes a substrate 424a and a plurality of LEDs 424b. The LEDs 424b are disposed on the substrate 424a. The protrusion 426 is disposed on the substrate 424a of the LED light source 424. A material of the protrusion 426 is metal, and the protrusion 426 has a plurality of first power contacts 426a. The light guide plate 428 is disposed between the back plate 422 and the LCD panel 410 and has a light entering surface 428a. In addition, a light emitting surface 424c of each of the LEDs 424b faces the light entering surface 428a of the light guide plate 428. The circuit board 430 is disposed under the back plate 422 (the circuit board 430 in FIG. 5 is located on the back plate 422) and electrically connected to the LCD panel 410. The circuit board 430 has a circuit layout 432 and a plurality of second power contacts 434, and the second power contacts 434 contact the first power contacts 426a of the protrusion 426 correspondingly. When the circuit board 430 is assembled to the bottom of the back plate 422, the second power contacts 434 of the circuit board 430 contact the first power contacts 426a of the protrusion 426, such that the LEDs 424b of the LED light source 424 are activated to emit light. In comparison with the conventional LCD, the LCD 400 in the present embodiment of the invention does not require the light source driving circuit board and the power connection line which is connected between the light source driving circuit board and the LED light source in the conventional LCD, and therefore material costs and assembling time can be reduced.

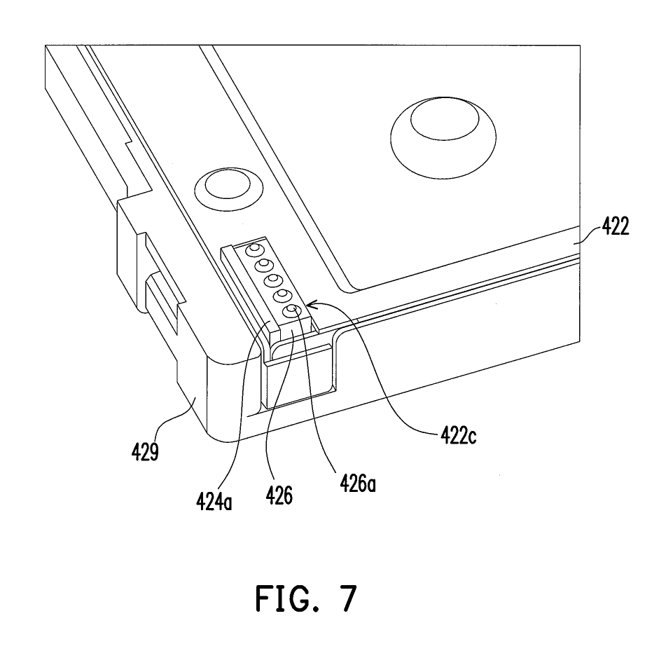

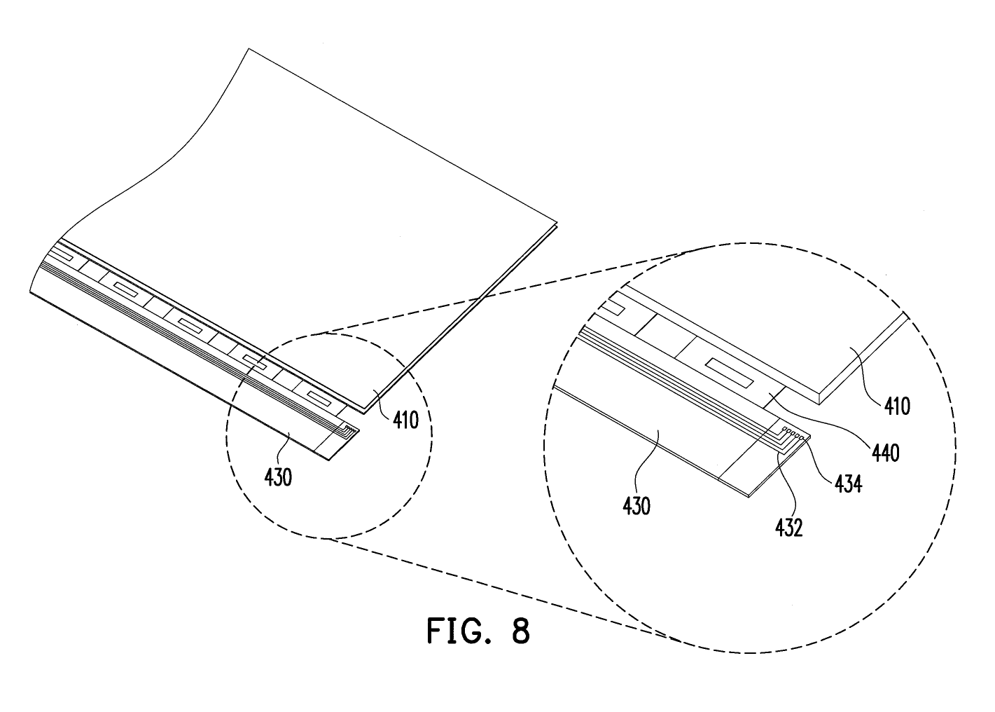

Referring to FIGS. 4, 5, and 6, the substrate 422 has an LED disposing region 422a and a protrusion disposing region 422b. The protrusion disposing region 422b is located at one side of the LED disposing region 422a, and the LEDs 424b are disposed in the LED disposing region 422a. The first power contacts 426a are disposed in the protrusion disposing region 422b. FIG. 7 is a schematic three-dimensional view illustrating the circuit board depicted in FIG. 5 when the circuit board is not placed on the back plate of the backlight module. It should be mentioned that the viewing angle depicted in FIG. 5 is different from that in FIG. 4, and thus the circuit board 430 in FIG. 5 appears to be disposed on the back plate 422. FIG. 8 is a schematic view of a circuit board and an LCD panel. Referring to FIGS. 7 and 8, the back plate 422 has an opening 422c exposing the first power contacts 426a of the protrusion 426. The first power contacts 426a protrude from the back plate 422. The LCD 400 further includes a flexible flat cable 440 connected between the LCD panel 410 and the circuit board 430. Here, the circuit layout 432 of the circuit board 430 has an LCD panel driving circuit for driving the LCD panel 410 and an LED light source driving circuit for driving an LED light source circuit 424.

Referring to FIGS. 4 and 6, the backlight module 420 further includes at least an optical film 427 which can be a diffusion film, a prism sheet, a brightness enhancement film, or a combination thereof. In FIGS. 4 and 6, three optical films 427 are schematically shown. The optical films 427 are disposed between the LCD panel 410 and the light guide plate 427. In addition, the LCD 400 further includes a front frame 450 for covering the LCD panel 410, such that the LCD panel 410 is fixed onto the backlight module 420.

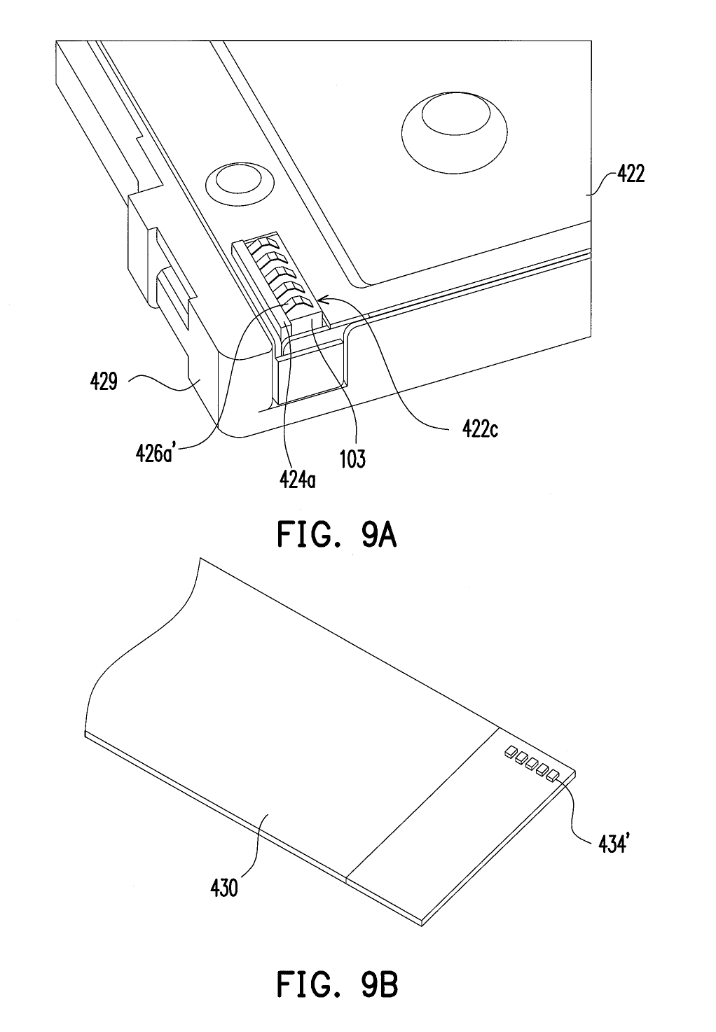

When the LCD panel 410 and the backlight module 420 are assembled together, the flexible flat cable 440 can be bent, such that the circuit board 430 can be disposed under the back plate 422. Here, the second power contacts 434 of the circuit board 430 contact the first power contacts 426a of the protrusion 426. Since the circuit layout 432 of the circuit board 430 has a circuit for driving the LCD panel 410 and a circuit for driving the LED light source 424, scan signals and data signals can be transmitted in the LCD panel 410, and the LEDs 424b of the LED light source 424 start to emit light. Thereby, frames can be displayed on the LCD 400. In the present embodiment, the first power contacts 426a are bumps, and the second power contacts 434 are bonding pads. Besides, the first power contacts 426a of the protrusion 426 can be exposed by the opening 422c, such that the first power contacts 426a and the second power contacts 434 can be well contacted. As long as the first power contacts 426a and the second power contacts 434 can be well contacted, people having ordinary skill in the art are capable of changing shapes of the first power contacts 426a and the second power contacts 434 based on actual demands. FIG. 9A is a schematic view of first power contacts according to another embodiment of the present invention. FIG. 9B is a schematic view of second power contacts according to another embodiment of the present invention. For instance, as shown in FIGS. 9A and 9B, first power contacts 426a′ can also be leaf springs, and second power contacts 434′ can also be bumps.

To sum up, in the LCD of the present application, the conventional light source driving circuit is integrated onto the circuit board used for driving the LCD panel of the conventional LCD, such that the use of power connection line and the light source driving circuit board in the conventional backlight module can be omitted, and that the material costs can be reduced. In addition, the step of assembling the circuit board to the bottom of the back plate is performed in the assembling process of the conventional LCD, and therefore no additional assembling steps are required for assembling the LCD of the present application. Instead, by not using the light source driving circuit board and the power connection line, the manual assembling steps and labor hour can be both reduced. Moreover, when the second power contacts on the circuit board contact the first power contacts of the protrusion on the substrate of the LED light source, the LED light source can be activated to emit light. Hence, in comparison with the conventional LCD, the LCD of the present application is advantageous of simple assembly.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A liquid crystal display, comprising:
a liquid crystal display panel; and
a backlight module disposed under the liquid crystal display panel and comprising:
a back plate;
a light emitting diode light source disposed in the back plate and comprising a substrate and a plurality of light emitting diodes, wherein the light emitting diodes are disposed on the substrate;
a protrusion disposed on the substrate of the light emitting diode light source and comprising a plurality of first power contacts;
a light guide plate disposed between the back plate and the liquid crystal display panel, wherein the light guide plate has a light entering surface, and a light emitting surface of each of the light emitting diodes faces the light entering surface of the light guide plate; and
a circuit board disposed under the back plate and electrically connected to the liquid crystal display panel, wherein the circuit board has a circuit layout and a plurality of second power contacts, and the second power contacts contact the first power contacts of the protrusion correspondingly.

2. The liquid crystal display as claimed in claim 1, wherein the substrate has a light emitting diode disposing region and a protrusion disposing region located at a side of the light emitting diode disposing region, the light emitting diodes are disposed in the light emitting diode disposing region, and the first power contacts are disposed in the protrusion disposing region.

3. The liquid crystal display as claimed in claim 1, wherein the back plate has an opening exposing the first power contacts of the protrusion.

4. The liquid crystal display as claimed in claim 3, wherein the first power contacts protrude from the back plate.

5. The liquid crystal display as claimed in claim 1, wherein the first power contacts are bumps, leaf springs, or bonding pads.

6. The liquid crystal display as claimed in claim 1, wherein the second power contacts are bumps, leaf springs, or bonding pads.

7. The liquid crystal display as claimed in claim 1, further comprising a front frame covering the liquid crystal display panel, such that the liquid crystal display panel is fixed onto the backlight module.

8. The liquid crystal display as claimed in claim 1, wherein the backlight module further comprises at least an optical film disposed between the liquid crystal display panel and the light guide plate.

9. The liquid crystal display as claimed in claim 8, wherein the at least an optical film is a diffusion film, a prism sheet, a brightness enhancement film, or a combination thereof.

10. The liquid crystal display as claimed in claim 1, further comprising a flexible flat cable connected between the liquid crystal display panel and the circuit board.
